(19) United States
(12) Patent Application Publication
(10) Pub. No.: US 2015/0277610 A1
(43) Pub. Date: Oct. 1, 2015

(54) APPARATUS AND METHOD FOR PROVIDING THREE-DIMENSIONAL AIR-TOUCH FEEDBACK

(71) Applicant: INDUSTRY-ACADEMIC COOPERATION FOUNDATION, YONSEI UNIVERSITY, Seoul (KR)

(72) Inventors: Kwangtaek KIM, Yongin (KR); Sangyoun LEE, Seoul (KR); Jaesung CHOI, Seoul (KR); Yuseok BAN, Seoul (KR)

(21) Appl. No.: 14/670,207

(22) Filed: Mar. 26, 2015

(30) Foreign Application Priority Data
Mar. 27, 2014 (KR) 10-2014-0036162

(51) Int. Cl. G06F 3/041

(52) U.S. Cl. CPC G06F 3/041

(57) ABSTRACT

Provided are three-dimensional air touch feedback apparatus and method for a mobile apparatus. The present invention provides an air touch feedback apparatus, including: a display unit which outputs a 3D floating image; a touch detecting unit which is disposed at a side edge of a display unit and includes a plurality of sensors to detect a body of a user and receives position information on at least one image object of the 3D floating image from the display unit to determine an air touch position where the body of the user is in contact with the image object; and a feedback providing unit which receives air touch position information from the touch detecting unit and radiates an ultrasonic wave to the air touch position at the side edge of the display unit.

### CROSS-REFERENCE TO RELATED APPLICATIONS

This application claims priority to and the benefit of Korean Patent Application No. 10-2014-0036162 filed in the Korean Intellectual Property Office on Mar. 27, 2014, the entire contents of which are incorporated herein by reference.

### TECHNICAL FIELD

The present invention relates to a feedback apparatus and method, and more particularly, to a 3D air touch feedback apparatus and method.

### BACKGROUND ART

In accordance with development of technology, user interfaces of various electronic apparatuses have been implemented through lots of changes. An initial user interface has been generally implemented using a physical element which performs mechanical operation, such as a button or a switch. In the electronic apparatus using a physical element, since interaction between the electronic apparatus and the user is performed based on direct manipulation of the user on the physical element, the user may intuitively recognize whether a command is input. Therefore, the electronic apparatus does not need to provide a separate feedback on whether a command of a user is input, to the user. However, in recent years, the user interface is changed to be a touch based user interface mainly for a mobile apparatus. As the user interface is changed to a touch based user interface, a touch panel or a touch screen, which is configured to directly receive a command in a position corresponding to an image which is displayed on the electronic apparatus to increase convenience for manipulation of the user, is widely spread. However, when a touch based user interface, such as a touch panel or a touch screen is used, it is difficult for the user to determine whether the command is input to the electronic apparatus. Accordingly, many mobile apparatuses include a feedback device which displays an image or generates a sound or vibration so that the user recognizes whether the command is input. That is, the user may easily determine whether the command is input to the electronic apparatus by a visual, audio, or haptic manner. Since among the above-mentioned various feedback methods, specifically, the haptic manner is less affected by surrounding circumstances, similarly to the manipulation of the physical element according to the related art, and the user may recognize whether the command is input without specifically paying attention thereto, the haptic manner is most widely used.

In the meantime, the image technology is developed from a two-dimensional (hereinafter, simply referred to as 2D) image of the related art to a three-dimensional floating image (or a 3D stereoscopic image). The three-dimensional floating image is generated as a stereoscopic image in a space where no physical object exists, differently from the 2D image of the related art which is output on a flat surface of a display unit of an electronic apparatus. Since the image is stereoscopically generated in the space, the user may be provided with a more realistic image, as compared with the 2D image.

According to a market research company, NPD DisplaySearch, a scale of a global market for a 3D display is expected to be about 67 billion dollars and sales volume is expected to reach about 226 million by the end of 2019, which are increased by 407.6% and 344.9%, respectively, as compared with the scale of a market and sales volume of the 3D display in 2011. Further, it is predicted that an auto stereoscopic display method is applied to a smart phone, a tablet PC, a digital camera, a camcorder, and a portable game player having a screen of 1 to 4 inches so that an auto stereoscopic display market is grown rapidly.

In contrast, due to absence of a physical medium, a technology which receives a user command corresponding to an image or haptically provides a feedback with respect to the input command to the user is insufficient. Therefore, a demand or expectation of adding a haptic feedback function is getting increased day by day. The haptic feedback function is necessary for a natural touch interaction with the user. Due to this reason, global display device manufacturers are scrambling to develop a haptic touch screen to which a haptic function is added, as a future technology.

Korean Patent Application Laid-Open No. 2009-0023919 discloses a technology which uses an electrostatic capacitive method, an IR method, and an electromagnetic resonance (EMR) method to detect a value of a position of a user's command applying unit (for example, a finger, an IR pen, and an EMR pen) in a space where no physical medium is provided to be applied with a command and generate a sound and a vibration with a level corresponding to a distance between the command applying unit and the electronic apparatus to provide feedback to the user. However, the above-mentioned technology is a technology which generates a sound or a vibration of the electronic apparatus and is a command applying unit which is not actually in contact with the electronic apparatus, so that a haptic feedback such as vibration may not be provided. Further, the sound or the vibration with the level simply corresponding to the distance may easily display a change of the distance in accordance with the movement of the command applying unit, but it is still difficult for the user to determine whether the command is input.

### SUMMARY OF THE INVENTION

The present invention has been made in an effort to provide a three-dimensional air touch feedback apparatus which detects air touch of a user on an object of a three-dimensional floating image and provides feedback corresponding to the air touch.

The present invention has been made in an effort to further provide a three-dimensional air touch feedback method.

An exemplary embodiment of the present invention provides an air touch feedback apparatus, including: a plurality of ultrasonic transducers which is disposed at opposite side edges of a display unit which displays a 3D floating image, and includes an ultrasonic element array configured by a plurality of ultrasonic wave generating elements to radiate the ultrasonic wave; a plurality of driving diffraction units which rotatably couples the plurality of ultrasonic transducers and corresponding side edges of the display unit and includes motors to rotate the corresponding ultrasonic transducer among the plurality of ultrasonic transducers around a coupling axis with the display unit; and a feedback position determining unit which determines an angle at which the ultrasonic wave is radiated by the plurality of ultrasonic transducers using air touch position information which is applied from the touch detecting unit which includes a plurality of sensors to detect a body of the user and controls the driving diffraction unit to rotate the plurality of ultrasonic transducers in accordance with the determined ultrasonic radiating angle.

The air touch feedback apparatus may further include: a phase signal storing unit which stores a plurality of phase control signals set in advance, selects a phase control signal corresponding to the distance between the plurality of ultrasonic transducers and the air touch position and the angle thereof, among the phase control signals, transmits the phase control signal which is selected so that the ultrasonic element array of the plurality of ultrasonic transducers forms a beam of the ultrasonic wave in the air touch position to be radiated.

Another exemplary embodiment of the present invention provides an air touch feedback apparatus, including: a case in which a display device which outputs a 3D floating image is fixed; a plurality of ultrasonic transducers which is disposed at opposite side edges of the display unit, and includes an ultrasonic element array configured by a plurality of ultrasonic wave generating elements to radiate the ultrasonic wave; a plurality of driving diffraction units which rotatably couples the plurality of ultrasonic transducers and the case at corresponding side edges of the display device and includes motors to rotate the corresponding ultrasonic transducer among the plurality of ultrasonic transducers around a coupling axis with the case; and a feedback position determining unit which determines an angle at which the ultrasonic wave is radiated by the plurality of ultrasonic transducers using air touch position information which is body location information of the user corresponding to the 3D floating image and controls the driving diffraction unit to rotate the plurality of ultrasonic transducers in accordance with the determined ultrasonic radiating angle.

The air touch feedback apparatus may further include: a touch detecting unit which includes a plurality of sensors to detect a body of the user, and receives position information on at least one image object of the 3D floating image from the display device to determine an air touch position where the body of the user is in contact with the image object, and transmits the determined air touch position information to the feedback position determining unit.

The touch detecting unit may include: a plurality of sensor units which is disposed at opposite sides of the case at the side edge of the display device and includes the plurality of sensors to detect the body of the user; a finger position tracking unit which tracks a position of a finger from the body of the user which is detected by the plurality of sensor units; and an air touch determining unit which receives position information on at least one image object from the display device and determines whether the position of the finger of the user is in contact with the image object to set the determined position as the air touch position information.

The touch detecting unit may further include: a user recognition correcting unit which stores a correcting value of data to correct a recognition position difference for the 3D floating image for every user, and transmits the stored correcting value to the air touch determining unit to determine the air touch position by applying the correcting value when the air touch determining unit determines the air touch position.

The touch detecting unit may further include: a plurality of sensor driving diffraction units which rotatably couples the plurality of sensor units to the case at the corresponding side edge of the display device, includes motors to rotate the corresponding sensor unit among the plurality of sensor units around a coupling axis with the display unit.

Still another exemplary embodiment of the present invention provides an air touch feedback apparatus, including: a display unit which outputs a 3D floating image; a touch detecting unit which includes a plurality of sensors to detect a body of a user and receives position information on at least one image object of the 3D floating image from the display unit to determine an air touch position where the body of the user is in contact with the image object; and a feedback generating unit which includes an ultrasonic element array disposed at the side edge of the display unit, receives the air touch position information from the touch detecting unit to adjust a aim angles of at least one pair of ultrasonic element arrays in the air touch position to radiate an ultrasonic wave.

The display unit may include an image output unit which receives image data to output the 3D floating image; and a data processing unit which generates the image data to output the image data to the image output unit and transmits position information on at least one image object in the image data to the touch detecting unit.

Yet another exemplary embodiment of the present invention provides an air touch feedback providing method of an air touch feedback apparatus including a touch detecting unit and a feedback generating unit, including: receiving, by the touch detecting unit, position information on at least one image object from a display device which outputs a 3D floating image; detecting, by the touch detecting unit, a body of a user using a plurality of sensors; determining, by the touch detecting unit, an air touch position where the body of the user is in contact with the image object; determining, by the feedback generating unit, a aim angle of a plurality of ultrasonic transducers coupled to be rotatable at a side edge of the display device by receiving and analyzing the air touch position; and generating, by the feedback generating unit, an air touch feedback, by rotating the plurality of ultrasonic transducers in the air touch position in accordance with the aim angle of the ultrasonic wave and radiating the ultrasonic wave using a plurality of ultrasonic elements provided in the plurality of ultrasonic transducers.

The generating of an air touch feedback, may include selecting, by the feedback generating unit, a phase control signal corresponding to a distance and an angle between the air touch position and the plurality of rotated ultrasonic transducers, among the plurality of stored phase control signals; and radiating, by the ultrasonic element array of the plurality of ultrasonic transducers, the ultrasonic wave by forming a beam of the ultrasonic wave in the air touch position, in response to the selected phase control signal.

The detecting of a body of the user may include: detecting, by the touch detecting unit, a body of a user using a plurality of sensors disposed at opposite side edges of the display unit; and tracking a position of a finger of the detected body of the user.

The determining of an air touch position may include determining whether the finger of the user is in contact with the image object by comparing position information on at least one image object with the position of the finger of the user; and setting the position of the finger as the air touch position when the finger of the user is in contact with the image object.

The determining of an air touch position may further include: before the determining whether to be in contact with the image object, by the touch detecting unit, applying the correcting value stored in a user recognition correcting unit of the touch detecting unit to the position information on the at least one image object in order to correct a recognition position difference for the 3D floating image for every user.

According to the three-dimensional air touch feedback apparatus, system, and method according to the exemplary embodiment of the present invention, it is determined whether there is air touch of the user on an object of a 3D floating image and position of the air touch using an IR sensor and an ultrasonic wave is radiated by adjusting an ultrasonic radiating angle of a plurality of feedback generating units provided at a side of an image output unit corresponding to the determined air touch position, thereby providing strong haptic feedback to the user at a precise position with a high spatial resolution. Further, since the ultrasonic wave radiating angle is adjusted, the apparatus may be manufactured with a reduced size and a reduced cost as compared with the case where the ultrasonic wave is generated in a display region and may be appropriately applied to a mobile apparatus because low power is consumed. Furthermore, even though the user works in front of an image output unit, the ultrasonic wave is prevented from being unnecessarily radiated on other body parts of the user, such as a face, for a long time due to the ultrasonic wave radiating angle, so that an issue of a user's safety risk is not caused by providing the haptic feedback. Specifically, the apparatus may be manufactured as an individual attachable device, so that portability of the mobile apparatus may be least affected. A correcting value for a difference of a three-dimensional floating image recognizing position for every user is reflected, so that more precise haptic feedback may be provided.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 and 2 illustrate a three-dimensional air touch feedback apparatus according to an exemplary embodiment of the present invention.

FIG. 3 illustrates a configuration of an air touch feedback apparatus according to an exemplary embodiment of the present invention.

FIG. 4 illustrates an example of a method of setting a rotation angle of a driving diffraction unit in accordance with an air touch position.

FIG. 5 illustrates an air touch feedback providing method according to an exemplary embodiment of the present invention.

FIG. 6 illustrates another example of an air touch feedback apparatus of the present invention.

FIG. 7 illustrates an air touch feedback system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In order to sufficiently understand the present invention, the operational advantages of the present invention, and the objectives achieved by the embodiments of the present invention, the accompanying drawings illustrating preferred embodiments of the present invention and the contents described therein need to be referred to.

Hereinafter, the present invention will be described in detail by explaining preferred embodiments of the present invention with reference to the accompanying drawings. However, the present invention can be realized in various different forms, and is not limited to the exemplary embodiments described herein. In order to clearly describe the present invention, a part which may obscure the present invention may be omitted and like reference numerals denote like components in the drawings.

In the specification, unless explicitly described to the contrary, the word “comprise” and variations such as “comprises” or “comprising”, will be understood to imply the inclusion of stated elements but not the exclusion of any other elements. In addition, the terms “unit”, “-er”, “-or”, “module”, and “block” described in the specification mean units for processing at least one function and operation and can be implemented by hardware components or software components and combinations thereof.

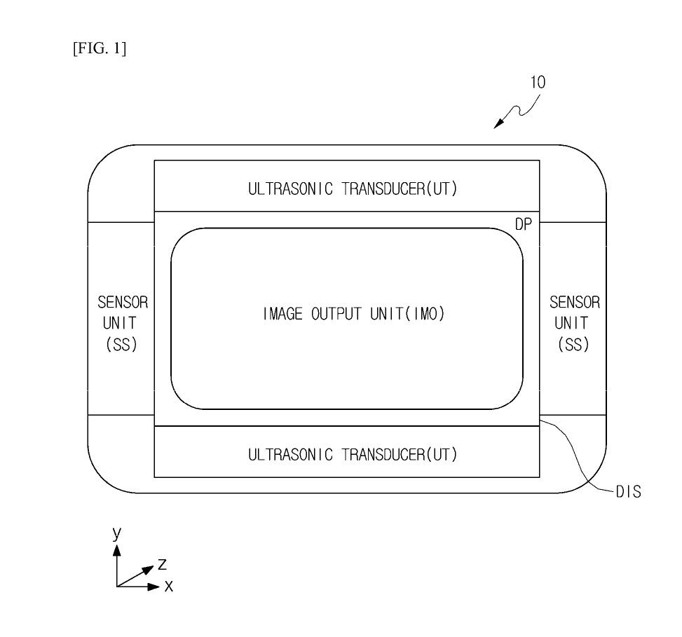

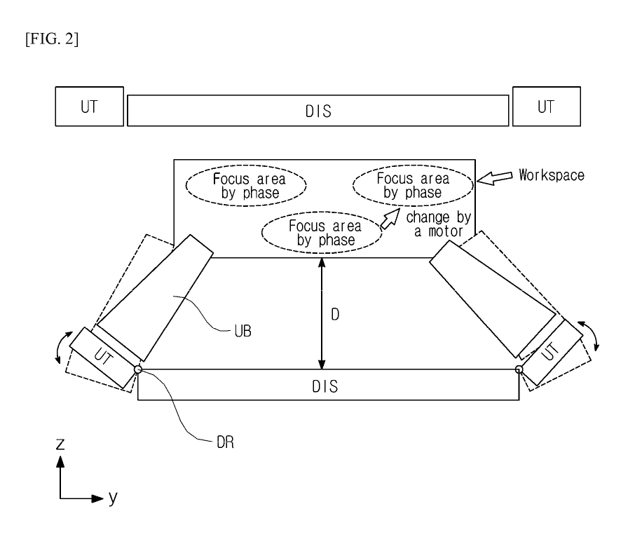

FIGS. 1 and 2 illustrate a three-dimensional air touch feedback apparatus according to an exemplary embodiment of the present invention.

Referring to FIGS. 1 and 2, a three-dimensional air touch feedback apparatus 100 according to an exemplary embodiment of the present invention includes a display unit DIS and a feedback providing unit. The display unit DIS includes an image output unit IMO which outputs a 3D floating image (or a 3D stereoscopic image or a hologram image) and a data processing unit DP which transmits image data to the image output unit IMO. In the exemplary embodiment of the present invention, the display unit DIS does not have a configuration which simply outputs an image, but also performs an operation as an information communication apparatus which processes various data in accordance with a function of the data processing unit DP. The image output unit IMO in the display unit DIS simply performs an operation of receiving the image data which is transmitted from the data processing unit DP to output the image data as a 3D floating image but the data processing unit DP performs a predetermined operation corresponding to the user command and outputs a result through the image output unit IMO again. That is, in the exemplary embodiment of the present invention, the display unit DIS may be configured to be the same as various electronic apparatuses of the related art which output the 3D floating image and may be considered as a separate display device. Therefore, the data processing unit DP may include an arithmetic device or a memory to record and process data, similarly to the electronic apparatus of the related art and may include an additional component such as a user interface including a speaker or a keyboard or a communication unit which communicates with other external device.

The feedback providing unit is an element which provides an air touch feedback to the user and includes a touch detecting unit and a feedback generating unit.

The touch detecting unit tracks and detects a position of a body part of the user, specifically, a finger and receives position information of at least one image object of the 3D floating image from the display unit DIS to determine whether the finger of the user is in contact with the position of the at least one image object. When it is determined that the finger is in contact with the position of the at least one image object, the touch detecting unit provides the determined air touch position to the feedback generating unit. In the exemplary embodiment of the present invention, air touch means that the user's finger is in touch with at least one image object of the 3D floating image.

The touch detecting unit includes a plurality of sensor units SS which is disposed at a side edge of the display unit DIS. The plurality of sensor units SS may be disposed in opposite positions among a plurality of side edges of the display unit DIS. The plurality of sensor units SS is disposed at opposite sides in order to simultaneously detect and compare the body part of the user at both side edges of the display unit DIS to exactly discriminate the position of the body part of the user. In FIG. 1, for example, even though two sensor units SS are disposed at opposite sides in an X-axis direction with respect to the display unit DIS, the number of sensor units SS and the disposing position may be adjusted. The plurality of sensor units SS may be implemented by including various sensors which may detect and discriminate of position of the body part of the user and in this exemplary embodiment of the present invention, it is assumed that an infrared sensor is used as an example. A technology of detecting the finger of the user using the infrared sensor is a known technology. A technique which radiates infrared rays using at least one IR LED and photographs the radiated infrared rays using at least one infrared camera to detect and track the position of the finger of the user may be used as a representative example.

The feedback generating unit includes a plurality of ultrasonic transducers UT which is disposed at a side edge of the display unit DIS and a plurality of driving diffraction units RR which couples the plurality of ultrasonic transducers UT to the display unit DIS to be rotatable like hinge coupling and rotates a corresponding ultrasonic transducer among the plurality of ultrasonic transducers UT around a coupling axis with the display unit DIS in order to adjust a radiating direction of the ultrasonic wave which is radiated from the plurality of ultrasonic transducers UT.

As illustrated in FIGS. 1 and 2, two sensor units SS may be disposed at opposite positions with respect to the display unit DIS and the plurality of ultrasonic transducers UT may be disposed so as not to overlap the position of the plurality of sensor units SS.

As a technology which provides haptic feedback to the user, currently, three technologies which use ultrasonic, air vortex and laser are representatively known. Table 1 represents characteristics of three feedback providing techniques.

TABLE 1

| | Ultrasound | Air Vortex | Laser |
|---|---|---|---|
| Max force | 16 mN @ 30 cm | 0.5 gf (5 mN) | A prototype is |
| | | @ 50 cm | being built but |
| Spatial Resolution | 20 mm | 85 mm | nothing opened |
| Speed | 340 m/s | 7.2 m/s | yet |
| Tactile stimulation | Good | No good | |
| Vibration feedback | Up to 1 KHz | Up to 30 Hz | |
| Continuous | Yes | No | |
| feedback | | | |
| Units | 100-200 units | 1-2 units | |
| | needed | | |
| Cost | Expensive | Less expensive | |

As represented in Table 1, among three techniques which provide haptic feedback, the technique using the laser has not been developed to be utilized as a product, so that the technique may not be actually applied. When the ultrasonic feedback technique and the air vortex feedback technique are compared, the ultrasonic feedback technique may provide a stronger feedback than the air vortex technique and may provide the feedback at a high response speed without being delayed with a higher spatial resolution of approximately 10 to 20 mm. Further, the ultrasonic feedback technique provides continuous feedback. Therefore, in the exemplary embodiment of the present invention, it is assumed that the feedback generating unit provides air touch feedback to the user using an ultrasonic wave and a plurality of ultrasonic transducers UT is provided.

Each of the plurality of ultrasonic transducers UT includes an ultrasonic element array which is configured by a plurality of ultrasonic wave generating elements. As represented in Table 1, in the feedback technique using the ultrasonic wave, since a strength of the ultrasonic wave which is generated by individual ultrasonic wave generating elements is not so strong, generally, 100 to 200 ultrasonic wave generating elements are used. In this case, the plurality of ultrasonic wave generating elements is arranged to have an array shape, so that a position where the ultrasonic wave is concentrated may be easily adjusted. By adjusting a phase of the ultrasonic wave which is radiated from the plurality of ultrasonic wave generating elements which is arranged to have an array pattern, the ultrasonic wave which is radiated from the plurality of ultrasonic wave generating elements forms a beam to adjust a position and a distance where the ultrasonic wave is focused. This is a known technique so that the detailed description thereof may be omitted.

Each of the plurality of driving diffraction units RR includes a motor to adjust aim angles of the plurality of ultrasonic transducers UT. The plurality of driving diffraction unit RR couples one side edge of the corresponding ultrasonic transducer UT and one side edge of the display unit DIS with the motor as an axis. The plurality of driving diffraction unit RR receives the air touch position of the touch detecting unit and drives the motor in accordance with the received air touch position to adjust the aim angle at which the ultrasonic wave is radiated from the ultrasonic transducer UT as illustrated in FIG. 2. In the above description, each of the plurality of ultrasonic transducers UT adjusts a phase of the ultrasonic wave which is radiated from each of the plurality of ultrasonic wave generating elements which is disposed to have an array pattern, so that the position of the focus where the ultrasonic wave is concentrated in a predetermined region (for example, a focus area of FIG. 2) and a distance may be adjusted, but a range of the focus area which may be controlled by adjusting the phase of the ultrasonic wave is very limited. Therefore, according to the exemplary embodiment of the present invention, the aim angle of the ultrasonic transducer UT which is disposed to be parallel to the display unit DIS is adjusted using the plurality of driving diffraction unit RR, so that an area where the air touch feedback is provided may be adjusted in various ways. As illustrated in FIG. 2, an area where the aim angle of the ultrasonic transducer UT is adjusted to provide the air touch feedback is referred to as a workspace in this exemplary embodiment. That is, the air touch feedback apparatus according to the exemplary embodiment of the present invention controls the driving diffraction unit RR to designate a focus area in the workspace and adjusts the phase of the ultrasonic wave which is radiated from the ultrasonic element array to focus the ultrasonic in a specific position in the designated focus area.

Even though in the related art, various technologies for providing the air touch feedback using the ultrasonic wave have been studied, there is no example that adjusts the aim angles of all of the plurality of ultrasonic wave generating elements which is disposed on a plane to have an array shape. That is, in the related art, the ultrasonic wave generating element array is implement to radiate the ultrasonic wave only in a Z direction which is the same as the direction in which the ultrasonic wave generating element array outputs the 3D floating image in the display unit DIS, so that the ultrasonic wave generating element array is disposed on a lower surface or an upper surface of the display unit DIS. Therefore, only a part of the plurality of ultrasonic wave generating elements which is disposed in an array pattern is driven to provide the ultrasonic wave in a specific position, so that it is difficult to provide strong air feedback. Further, in order to provide air touch feedback in all areas of the 3D floating image which is output from the image output unit IMO, a size of the ultrasonic transducer UT may be implemented to be equal to or larger than a size of the image output unit IMO. Therefore, a large number of ultrasonic wave generating elements are required. Further, the position of the display unit DIS and the position of the feedback driving unit overlap, which causes a thickness of the air touch feedback apparatus to be increased. Further, since the ultrasonic wave is radiated onto the front surface of the image output unit IMO, even though the distance D from the image output unit IMO to the air touch position is changed, the air touch feedback is not changed. Further, continuous ultrasonic wave is radiated into a body part of the user, other than the finger of the user which mainly performs the job in front of the image output unit IMO, which applies harmful influence to the body of the user.

However, as illustrated in FIG. 2, the air touch feedback apparatus 100 of the exemplary embodiment of the present invention provides a strong air touch feedback in an area where the radiated ultrasonic waves intersect, only by the reduced number of ultrasonic wave generating elements by radiating the ultrasonic wave by rotating the ultrasonic transducers UT disposed at both side edges of the display unit DIS using the driving diffraction unit RR, with a directive direction adjusted. In contrast, the strength of the ultrasonic wave may be significantly lowered in other position. Further, the directive direction of the ultrasonic wave is different from an output direction of the 3D floating image output from the image output unit IMO, so that unnecessary ultrasonic wave may not be radiated to the user who performs the job mainly in front of the image output unit IMO. That is, safety of the user may be secured.

In the above description, it is described that only the ultrasonic transducer UT of the feedback generating unit is rotated by the driving diffraction unit RR. The touch detecting unit also further includes a number of driving diffraction unit RR corresponding to the plurality of sensor units SS so that the plurality of sensor units SS rotates around the coupling axis with the display unit DIS, similarly to the ultrasonic wave transducer UT.

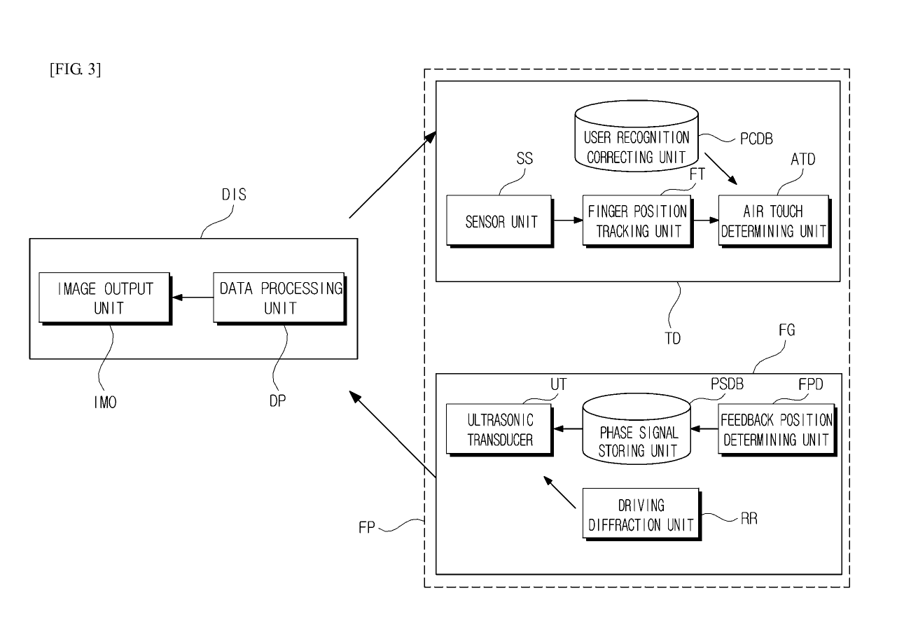

FIG. 3 illustrates a configuration of an air touch feedback apparatus according to an exemplary embodiment of the present invention.

In FIG. 3, similarly to FIG. 1, the display unit DIS includes an image output unit IMO and a data processing unit DP. Since operations of the image output unit IMO and the data processing unit DP have been described, separate description will be omitted here.

The touch detecting unit TD of the feedback providing unit includes a plurality of sensor units SS which detects a body of the user, a finger position tracking unit FT which tracks a position of the finger from the body of the user detected by the plurality of sensor units SS, a user recognition correcting unit PCDB which stores data for correcting the difference of the recognition position for the 3D floating image for individual users, and an air touch determining unit ATD which determines whether there is air touch and the position of the air touch.

The plurality of sensor units SS, as described above, is disposed at both side opposite edges of the display unit DIS and includes a sensor such as an infrared LED and an infrared camera to detect the body of the user. The finger position tracking unit FT tracks the position of the finger of the user using the body information of the user which is detected by the plurality of sensor units SS.

The user recognition correcting unit PCDB stores recognition correction data in accordance with the users. Even though the display unit DIS outputs the same image, a position of an object and a stereoscopic depth of the 3D floating image which are actually recognized by the user may be different from the output image. This is because most 3D images including the 3D floating image are provided so as to use a binocular disparity and each people may have different binocular disparity from each other. Therefore, even in the same 3D floating image, the users may differently recognize the position of the image object and the position of the image object which is touched by the user may be differently determined. Therefore, in the exemplary embodiment of the present invention, a position correcting value in accordance with the difference of the recognition position for every user is stored in the user recognition correcting unit PCDB in advance and the position correcting value is reflected and detected when the air touch of the user is detected later. The position correcting value may be obtained by outputting the predetermined 3D floating image through the display unit DIS and causing the user to touch a predetermined specific reference position in the 3D floating image, to determine the touched position.

The air touch determining unit ATD corrects the position information of the finger of the user which is tracked by the finger position tracking unit FT using the recognition correcting value stored in the user recognition correcting unit PCDB and receives rendering data for the 3D floating image which is currently output from the image output unit IMO from the data processing unit DP of the display unit DIS to obtain position information of each of the image objects. The corrected finger position information is compared with the position information of the image object to analyze whether the image object and the position of the finger overlap, that is, there is a collision position to determine whether air touch is generated. When it is determined that the air touch is generated, the air touch determining unit ATD transmits a position where the air touch is generated, that is, the air touch position information to the feedback generating unit FG.

The feedback generating unit FG includes a feedback position determining unit FPD, a driving diffraction unit RR, a phase signal storing unit PSDB, and an ultrasonic transducer UT. The feedback position determining unit FPD receives the air touch position information which is transmitted from the air touch determining unit ATD and determines a feedback position where the air touch feedback is provided in response to the received air touch position information. The driving diffraction unit RR receives the feedback position information from the feedback position determining unit FPD and adjusts an angle of the plurality of ultrasonic transducers UT so as to correspond to the feedback position in accordance with the received feedback position information. The plurality of ultrasonic adjusting units UT whose angle is adjusted by the driving diffraction unit RR forms a focus area where the radiated ultrasonic waves intersect. The phase signal storing unit PSDB obtains a phase control signal such that the ultrasonic element array of the plurality of ultrasonic adjusting units UT forms the beam of the ultrasonic wave to radiate the ultrasonic wave in the air touch position and transmits the phase control signal to the plurality of ultrasonic transducers UT. Each of the plurality of ultrasonic transducers UT radiates and outputs the ultrasonic wave in response to the phase control signal which is applied from the phase signal storing unit PSDB, so that the air touch feedback is generated in an exact air touch position also in the focus area. A technology of adjusting the radiation position of the ultrasonic wave by controlling a phase is a known technology, so that the detailed description will be omitted here.

The feedback generating unit FG transmits the position information of the focus area to the data processing unit DP of the display unit DIS and the data processing unit DP displays the air touch position in the 3D floating image which is output to the image output unit IMO. That is, the user may visually receive the feedback of the air touch position. As another method of visually displaying the air touch position, the feedback generating unit FG does not transmit the position information of the focus area to the data processing unit DP, but may transmit the air touch position which is determined by the air touch determining unit ATD of the touch detecting unit TD to the data processing unit DP.

Even though not illustrated, the feedback generating unit FG also may further include a user feedback correcting unit. The user feedback correcting unit outputs the 3D floating image which is visually represented by setting the touch position in advance by the display unit DIS, similarly to the user recognition correcting unit PCDB, and radiates the ultrasonic wave with touch position as a focus area to input the position where the user detects the air touch feedback, so that a correcting value for an error of the feedback position for every user may be stored in advance.

In the above description, it is described that when the position of the finger and the position of the image object collide, the air touch determining unit ATD determines that the air touch occurs, but there is no need to provide air touch feedback whenever all the image object and the finger collide in some cases. That is, an important image object for which the feedback needs to be provided and an image object for which the feedback does not need to be provided may coexist also in the 3D floating image output from the display unit DIS. Therefore, the data processing unit DP of the display unit DIS does not transmit the rendering data for all images output from the image output unit IMO, but transmits only the rendering information or the position information on image objects for which the feedback needs to be provided to the touch detecting unit TD. When only the position information on a specific image object is transmitted to the touch detecting unit TD, an amount of data to be transmitted is reduced and a size of an area where the touch detecting unit TD determines the air touch is limited, so that the air touch may be more exactly determined. Further, as each image object for which the air touch feedback is provided is distinguished, the feedback generating unit FG may change the pattern of the air touch feedback for every image object in various ways.

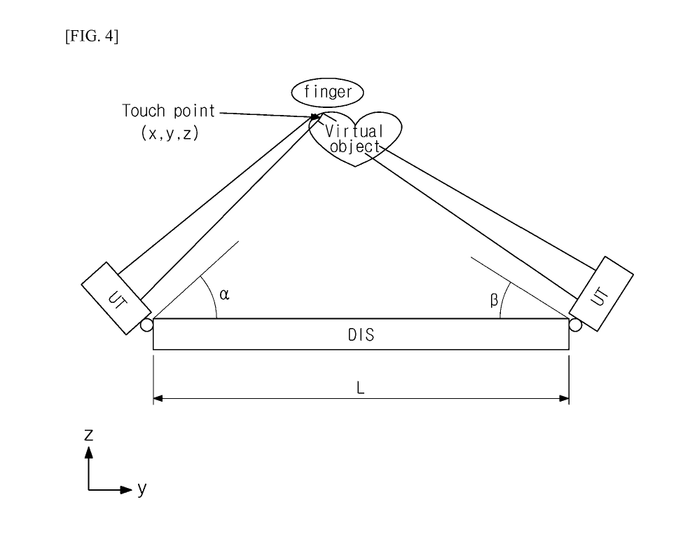

FIG. 4 illustrates an example of a method of setting a rotation angle of a driving diffraction unit in accordance with air touch position.

As illustrated in FIG. 4, when a distance of the display unit DIS when the ultrasonic transducers UT are coupled using the driving diffraction unit RR at both side edges, that is, a disposing distance between the ultrasonic transducers UT is L, and the air touch position is (x, y, z), angles α and β at which two ultrasonic transducers UT radiate the ultrasonic wave to the display unit DIS may be calculated by Equation 1.

$$α = arctan \frac{y}{x} \\ β = arctan \frac{y}{L - x} \qquad Equation 1$$

The driving diffraction unit RR rotates by 90-α degrees and 90-β degrees in accordance with the angles α and β calculated by Equation 1, so that the ultrasonic transducer UT generates the focus area in the air touch position.

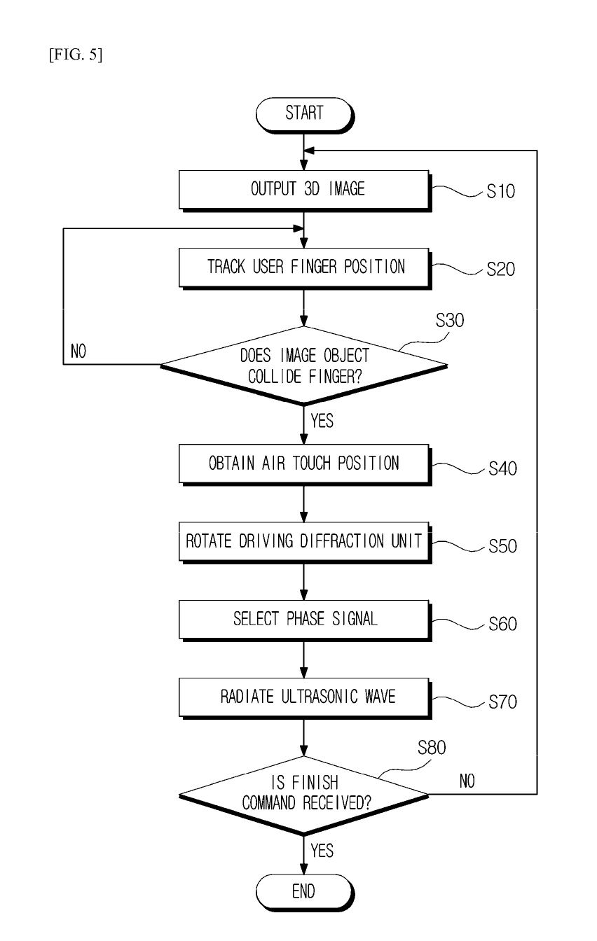

FIG. 5 illustrates an air touch feedback providing method according to an exemplary embodiment of the present invention.

An air touch feedback providing method of FIG. 5 will be described with reference to FIGS. 1 to 4. The air touch feedback apparatus outputs the 3D floating image and transmits rendering data corresponding to the output 3D floating image to the touch detecting unit TD in step S10. The touch detecting unit TD tracks a position of a user's finger using a plurality of sensor units SS and calculates a position of the image object from the rendering data in step S20. In this case, when the recognition correcting value is set in the user recognition correcting unit PCDB, the touch detecting unit TD applies the recognition correcting value to the position information of the image object to correct the position information of the image object. Further, the touch detecting unit TD determines whether the tracked position of the finger collides the image object of the 3D floating image in step S30. When it is determined that the position of the user's finger collides the image object, the collision position is obtained as an air touch position and the obtained air touch position is transmitted to the feedback generating unit FG in step S40. Here, the air touch position may be set to be obtained only when the finger collides a specific image object, rather than when the finger collides all image objects.

The feedback generating unit FG receives the air touch position and rotates the driving diffraction unit RR in order to form the focus area corresponding to the received air touch position to adjust the aim angle of the ultrasonic wave which is radiated from the plurality of ultrasonic transducers UT in step S50. A distance from the ultrasonic transducer UT to the air touch position and an angle thereof are calculated and a phase control signal which is stored in advance and corresponds to the calculated distance and angle is selected, among the phase control signals which are stored in the phase signal storing unit in advance in step S60. When the phase control signals for the plurality of ultrasonic transducers UT are selected, the plurality of ultrasonic transducers receives the corresponding phase control signal and forms a beam of the ultrasonic wave in accordance with the phase control signal to be radiated, thereby providing the air touch feedback to the user in step S70.

The air touch feedback apparatus 100 determines whether an end command is applied and outputs the 3D floating image again when the completed command is not applied in step S10.

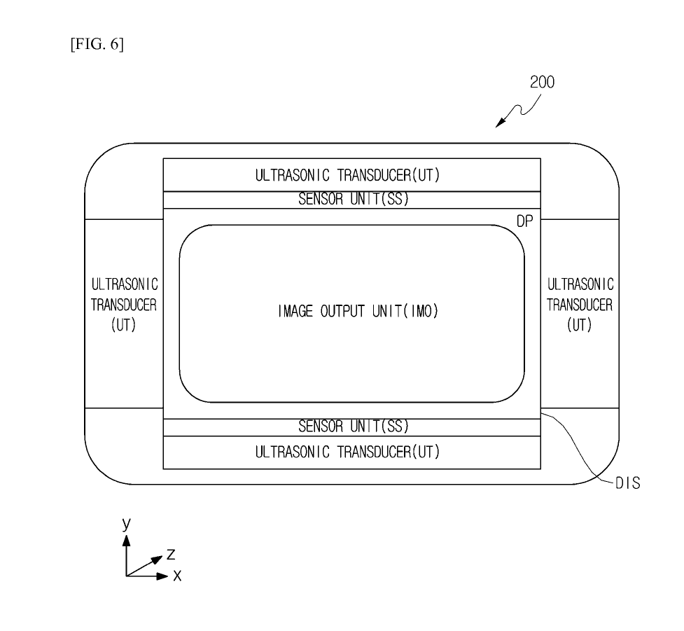

FIG. 6 illustrates another example of an air touch feedback apparatus of the present invention.

In the air touch feedback apparatus illustrated in FIG. 1, a plurality of sensor units SS is disposed at both ends of the display unit DIS in an X-axis direction and a plurality of ultrasonic transducers UT is disposed at both ends of the display unit DIS in the X-axis direction so as not to overlap the plurality of sensor units SS and the plurality of ultrasonic transducers UT. However, positions of the plurality of sensor units SS and positions of the plurality of ultrasonic transducers UT may be changed. Further, in some cases, as illustrated in FIG. 6, the ultrasonic transducers UT may be provided at all side edges of the display unit DIS. In this case, the sensor units SS may be disposed together with the ultrasonic transducer UT which is disposed in the X-axis direction or the Y-axis direction and similarly to the ultrasonic transducer UT, disposed at all side edges of the display unit DIS. When the plurality of ultrasonic transducers is disposed at all side edges of the display unit DIS, as illustrated in FIG. 6, the ultrasonic transducer which is disposed in the X direction and the ultrasonic transducer which is disposed in the Y direction may provide air touch feedbacks for different areas, so as to not only extend an area of the workspace but also to correspond to the multi touch. When the air touch feedback is provided in the same area, stronger air touch feedback may be provided.

In FIG. 6, even though the sensor unit SS is disposed between the ultrasonic transducer UT and the display unit DIS, the ultrasonic transducer UT may be disposed between the sensor unit SS and the display unit DIS.

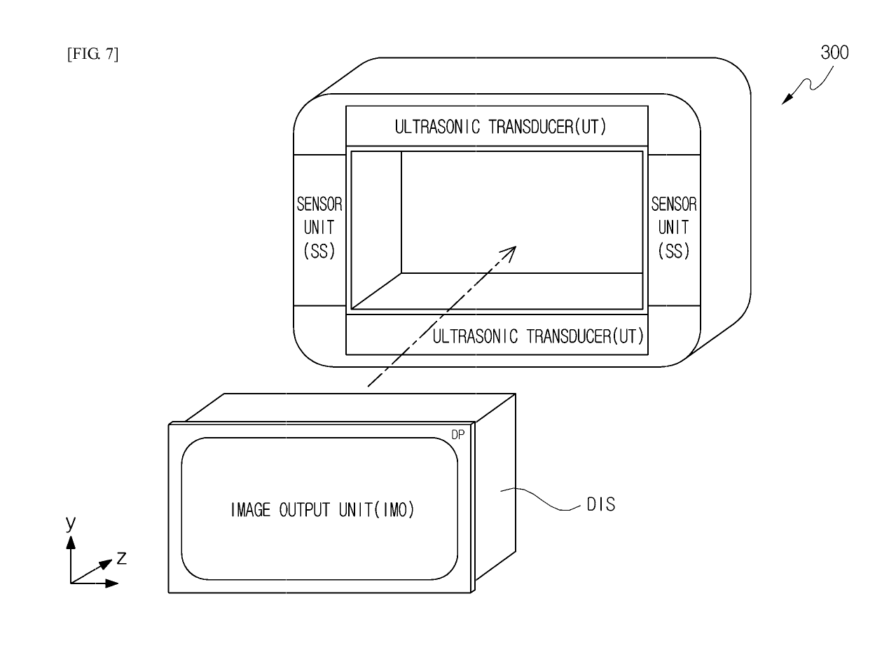

FIG. 7 illustrates an air touch feedback system according to an exemplary embodiment of the present invention.

In the above description, as an air touch feedback apparatus, an apparatus in which the display unit DIS and the feedback providing unit FD are configured in one body has been described. However, in some cases, portability of an electronic apparatus may be more important than air touch feedback. Further, in some cases, the air touch feedback function may be additionally provided in the electronic apparatus which may provide the 3D floating image in the related art. In this case, as illustrated in FIG. 7, when a structure which separates the air touch feedback providing function and the display unit DIS as a wide use electronic apparatus as a display device and the feedback providing unit FP as an air touch feedback device is provided, and the air touch feedback may also be provided to the electronic apparatus which not only increases the portability of the electronic apparatus but also provides the 3D floating image of the related art. As described above, the display device DIS may be configured by various electronic apparatuses, in accordance with the function of the data processing unit DP. The display device DIS and the air touch feedback device FP may be configured to wirely or wirelessly transmit and receive data. Specifically, the display device DIS transmits the position information on the image object to the air touch feedback device FP using a short range wireless communication method, such as Bluetooth or WiFi, as a wireless communication method and the air touch feedback device FP may transmit the air touch feedback position information to the display device DIS.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An air touch feedback apparatus, comprising:
a plurality of ultrasonic transducers which is disposed at opposite side edges of a display unit which outputs a 3D floating image, and includes an ultrasonic element array configured by a plurality of ultrasonic wave generating elements to radiate the ultrasonic wave;
a plurality of driving diffraction units which rotatably couples the plurality of ultrasonic transducers and corresponding side edges of the display unit and includes motors to rotate the corresponding ultrasonic transducer among the plurality of ultrasonic transducers around a coupling axis with the display unit; and
a feedback position determining unit which determines an angle at which the ultrasonic wave is radiated by the plurality of ultrasonic transducers using air touch position information which is applied from the touch detecting unit which includes a plurality of sensors to detect a body of the user and controls the driving diffraction unit to rotate the plurality of ultrasonic transducers in accordance with the determined ultrasonic radiating angle.

2. The apparatus of claim 1, further comprising:
a phase signal storing unit which stores a plurality of phase control signals set in advance, selects a phase control signal corresponding to the distance between the plurality of ultrasonic transducers and the air touch position and the angle thereof, among the phase control signals, transmits the phase control signal which is selected so that the ultrasonic element array of the plurality of ultrasonic transducers forms a beam of the ultrasonic wave in the air touch position to be radiated.

3. An air touch feedback apparatus, comprising:
a case in which a display device which outputs a 3D floating image is fixed;
a plurality of ultrasonic transducers which is disposed at opposite side edges of the display device, and includes an ultrasonic element array configured by a plurality of ultrasonic wave generating elements to radiate the ultrasonic wave;
a plurality of driving diffraction units which rotatably couples the plurality of ultrasonic transducers and the case at corresponding side edges of the display device and includes motors to rotate the corresponding ultrasonic transducer among the plurality of ultrasonic transducers around a coupling axis with the case; and
a feedback position determining unit which determines an angle at which the ultrasonic wave is radiated by the plurality of ultrasonic transducers using air touch position information which is body location information of the user corresponding to the 3D floating image and controls the driving diffraction unit to rotate the plurality of ultrasonic transducers in accordance with the determined ultrasonic radiating angle.

4. The apparatus of claim 3, further comprising:
a phase signal storing unit which stores a plurality of phase control signals set in advance, selects a phase control signal corresponding to the distance between the plurality of ultrasonic transducers and the air touch position and the angle thereof, among the phase control signals, transmits the phase control signal which is selected so that the ultrasonic element array of the plurality of ultrasonic transducers forms a beam of the ultrasonic wave in the air touch position to be radiated.

5. The apparatus of claim 4, further comprising:
a touch detecting unit which includes a plurality of sensors to detect a body of the user, receives position information on at least one image object of the 3D floating image from the display device to determine an air touch position where the body of the user is in contact with the image object, and transmits the determined air touch position information to the feedback position determining unit.

6. The apparatus of claim 5, wherein the touch detecting unit includes:
a plurality of sensor units which is disposed at opposite sides of the case at the side edge of the display device and includes the plurality of sensors to detect the body of the user;
a finger position tracking unit which tracks a position of a finger from the body of the user which is detected by the plurality of sensor units; and
an air touch determining unit which receives position information on the at least one image object from the display device and determines whether the position of the finger of the user is in contact with the image object to set the determined position as the air touch position information.

7. The apparatus of claim 6, wherein the touch detecting unit further includes:
a user recognition correcting unit which stores a correcting value of data to correct a recognition position difference for the 3D floating image for every user, transmits the stored correcting value to the air touch determining unit to determine the air touch position by applying the correcting value when the air touch determining unit determines the air touch position.

8. The apparatus of claim 6, wherein the touch detecting unit further includes:
a plurality of sensor driving diffraction units which rotatably couples the plurality of sensor units to the case at the corresponding side edge of the display device, and includes motors to rotate the corresponding sensor unit among the plurality of sensor units around a coupling axis with the display unit.

9. An air touch feedback apparatus, comprising:
a display unit which outputs a 3D floating image;
a touch detecting unit which includes a plurality of sensors to detect a body of a user and receives position information on at least one image object of the 3D floating image from the display unit to determine an air touch position where the body of the user is in contact with the image object; and
a feedback generating unit which includes an ultrasonic element array disposed at the side edge of the display unit, and receives the air touch position information from the touch detecting unit to adjust a aim angle of at least one pair of ultrasonic element arrays in the air touch position to radiate an ultrasonic wave.

10. The apparatus of claim 9, wherein the feedback generating unit includes:
a plurality of ultrasonic transducers which is disposed at opposite side edges of the display unit, and includes an ultrasonic element array configured by a plurality of ultrasonic wave generating elements to radiate the ultrasonic wave;
a plurality of driving diffraction units which rotatably couples the plurality of ultrasonic transducers and corresponding side edges of the display unit and includes motors to rotate the corresponding ultrasonic transducer among the plurality of ultrasonic transducers around a coupling axis with the display unit; and
a feedback position determining unit which determines an angle at which the ultrasonic wave is radiated by the plurality of ultrasonic transducers using air touch position information which is applied from the touch detecting unit and controls the driving diffraction unit to rotate the plurality of ultrasonic transducers in accordance with the determined ultrasonic radiating angle.

11. The apparatus of claim 9, wherein the display unit includes:
an image output unit which receives image data to output the 3D floating image; and
a data processing unit which generates the image data to output the image data to the image output unit and transmits position information on the at least one image object in the image data to the touch detecting unit.

12. An air touch feedback providing method of an air touch feedback apparatus including a touch detecting unit and a feedback generating unit, the method comprising:
receiving, by the touch detecting unit, position information on at least one image object from a display device which outputs a 3D floating image;
detecting, by the touch detecting unit, a body of a user using a plurality of sensors;
determining, by the touch detecting unit, an air touch position where the body of the user is in contact with the image object;
determining, by the feedback generating unit, a aim angle of a plurality of ultrasonic transducers coupled to be rotatable at a side edge of the display device by receiving and analyzing the air touch position; and
generating, by the feedback generating unit, an air touch feedback, by rotating the plurality of ultrasonic transducers in the air touch position in accordance with the aim angle of the ultrasonic wave and radiating the ultrasonic wave using a plurality of ultrasonic elements provided in the plurality of ultrasonic transducers.

13. The method of claim 12, wherein the generating of an air touch feedback, includes:
selecting, by the feedback generating unit, a phase control signal corresponding to a distance and an angle between the air touch position and the plurality of rotated ultrasonic transducers, among the plurality of stored phase control signals; and
radiating, by the ultrasonic element array of the plurality of ultrasonic transducers, the ultrasonic wave by forming a beam of the ultrasonic wave in the air touch position, in response to the selected phase control signal.

14. The method of claim 12, wherein the detecting of a body of the user includes:
detecting, by the touch detecting unit, a body of a user using a plurality of sensors disposed at opposite side edges of the display unit; and
tracking a position of a finger in the detected body of the user.

15. The method of claim 14, wherein the determining of an air touch position includes:
determining whether the finger of the user is in contact with the image object by comparing position information on the at least one image object with the position of the finger of the user; and
setting the position of the finger as the air touch position when the finger of the user is in contact with the image object.

16. The method of claim 15, wherein the determining of an air touch position further includes:
before the determining whether to be in contact with the image object, by the touch detecting unit, applying the correcting value stored in a user recognition correcting unit of the touch detecting unit to the position information on the at least one image object in order to correct a recognition position difference for the 3D floating image for every user.
